(19) United States
(12) Patent Application Publication
(10) Pub. No.: US 2023/0252814 A1
(43) Pub. Date: Aug. 10, 2023

(54) METHOD AND APPARATUS FOR EXTRACTING HUMAN OBJECTS FROM VIDEO AND ESTIMATING POSE THEREOF

(71) Applicant: SANGMYUNG UNIVERSITY INDUSTRY-ACADEMY COOPERATION FOUNDATION, Seoul (KR)

(72) Inventors: Dong Keun KIM, Seoul (KR); Hyun Jung KANG, Seoul (KR); Jeong Hwi LEE, Seoul (KR)

(73) Assignee: SANGMYUNG UNIVERSITY INDUSTRY-ACADEMY COOPERATION FOUNDATION, Seoul (KR)

(21) Appl. No.: 17/707,304

(22) Filed: Mar. 29, 2022

(30) Foreign Application Priority Data
Feb. 9, 2022 (KR) 10-2022-0017158

(51) Int. Cl. G06V 40/10; G06V 10/40; G06V 10/82; G06T 7/70; G06T 7/246

(52) U.S. Cl. CPC G06V 40/103; G06V 10/40; G06V 10/82; G06T 7/70; G06T 7/246; G06T 2207/30196

(57) ABSTRACT

A method and an apparatus for separating a human object from video and estimating a posture, the method including: obtaining video of one or more real people, using a camera; generating a first feature map object having multi-layer feature maps down-sampled to different sizes from a frame image, by processing the video in units of frames; obtaining an upsampled multi-layer feature map by upsampling the multi-layer feature maps of the first feature map object, and obtaining a second feature map object, by performing convolution on the upsampled multi-layer feature map with the first feature map; detecting and separating a human object corresponding to the one or more real people from the second feature map object; and detecting a keypoint of the human object.

### CROSS-REFERENCE TO RELATED APPLICATION

This application is based on and claims priority under 35 U.S.C. § 119 to Korean Patent Application No. 10-2022-0017158, filed on Feb. 9, 2022, in the Korean Intellectual Property Office, the disclosure of which is incorporated by reference herein in its entirety.

### BACKGROUND

### 1. Field

One or more embodiments relate to a method of detecting and separating a human object from a real-time video and estimating a posture or gesture of the human object at the same time, and an apparatus for applying the same.

### 2. Description of the Related Art

A digital human in a virtual space is an artificially modeled image character, which may imitate the appearance or posture of a real person in a real space. Through these digital humans, the demand for real people to express themselves in a virtual space is increasing.

Such a digital human may be applied to a sports field, an online education field, an animation field, and the like. External factors considered to express a real person through a digital human include realistic modeling of a digital human and imitated gestures, postures, and facial expressions. The gesture of a digital human is a very important communication element that accompanies the natural expression of human communication. These digital humans aim to communicate verbally and nonverbally with others.

Research for diversifying the target of communication or information delivery by characters in a virtual space, such as digital humans, will be able to provide higher-quality video services.

### SUMMARY

One or more embodiments include a method and an apparatus capable of extracting a character of a real person expressed in a virtual space from video and detecting the pose or posture of the character.

One or more embodiments include a method and an apparatus capable of realizing a character of a real person in a virtual space and detecting information about the posture or gesture of the real person as data.

Additional aspects will be set forth in part in the description which follows and, in part, will be apparent from the description, or may be learned by practice of the presented embodiments of the disclosure.

According to one or more embodiments, a method of separating a human object from video and estimating a posture includes:

obtaining video of one or more real people, using a camera;

generating a first feature map object having multi-layer feature maps down-sampled to different sizes from a frame image by processing the video in units of frames through an object generator;

through a feature map converter, obtaining an upsampled multi-layer feature map by upsampling the multi-layer feature maps of the first feature map object, and obtaining a second feature map object, by performing convolution on the upsampled multi-layer feature map with the first feature map;

detecting and separating a human object corresponding to the one or more real people from the second feature map object through an object detector; and

detecting a keypoint of the human object through a keypoint detector.

According to an embodiment, the first feature map object may have a size in which the multi-layer feature map is reduced in a pyramid shape.

According to another embodiment, the first feature map object may be generated by a convolutional neural network (CNN)-based model.

According to another embodiment, the object converter may perform 1:1 transport convolution on the first feature map object along with upsampling.

According to another embodiment, the object detector may generate a bounding box surrounding a human object from the second feature map object and a mask coefficient, and detect a human object inside the bounding box.

According to another embodiment, the object detector extracts a plurality of features from the second feature map object and generates a mask of a certain size.

According to another embodiment, the keypoint detector may perform keypoint detection using a machine learning-based model on the human object separated in the above process, extract coordinates and movement of the keypoint of the human object, and provide the information.

According to one or more embodiments, an apparatus for separating a human object from video by the above method and estimating a posture of the human object includes:

a camera configured to obtain video from one or more real people;

an object generator configured to process video in units of frames and generate a first feature map object having multi-layer feature maps down-sampled to different sizes from a frame image;

a feature map converter configured to obtain an upsampled multi-layer feature map by upsampling the multi-layer feature maps of the first feature map object, and generate a second feature map object, by performing convolution on the upsampled multi-layer feature map with the first feature map;

an object detector configured to detect and separate a human object corresponding to the one or more real people from the second feature map object; and

a keypoint detector configured to detect a keypoint of the human object and provide the information.

According to an embodiment, the first feature map object may have a size in which the multi-layer feature map is reduced in a pyramid shape.

According to another embodiment, the first feature map object may be generated by a convolutional neural network (CNN)-based model.

According to an embodiment, the object converter may perform 1:1 transport convolution on the first feature map object along with upsampling.

According to an embodiment, the object detector may generate a bounding box surrounding a human object from the second feature map object and a mask coefficient, and detect a human object inside the bounding box.

According to another embodiment, the object detector extracts a plurality of features from the second feature map object and generates a mask of a certain size.

According to an embodiment, the keypoint detector may perform keypoint detection using a machine learning-based model on the human object separated in the above process, extract coordinates and movement of the keypoint of the human object, and provide the information.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart illustrating an outline of a method of separating a human object from video and estimating a posture, according to the disclosure;

FIG. 2 is a view illustrating a result of a human object extracted and separated from a raw image through step-by-step image processing according to the process of a method according to the disclosure;

FIG. 3 is a view illustrating an image processing result in a process of separating a human object, according to an embodiment of a method according to the disclosure;

FIG. 4 is a flowchart illustrating a process of generating a feature map according to the disclosure;

FIG. 5 is a view illustrating a comparison between a circular image and a state in which a human object is extracted therefrom, according to the disclosure;

FIG. 6 is a flowchart illustrating a parallel processing process for extracting a human object from a circular image, according to the disclosure;

FIG. 7 is a view illustrating a prototype filter by a prototype generation branch in parallel processing according to the disclosure;

FIG. 8 is a view illustrating a result of linearly combining parallel processing results according to the disclosure;

FIG. 9 is a view illustrating a comparison between a circular image and an image obtained by separating a human object from the circular image by a method of separating a human object from video and estimating a posture, according to the disclosure; and

FIG. 10 is a view illustrating a keypoint inference result of a human object in a method of separating a human object from video and estimating a posture, according to the disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Reference will now be made in detail to embodiments of the disclosure, examples of which are illustrated in the accompanying drawings. However, embodiments of the inventive concept will now be described more fully with reference to the accompanying drawings, in which the embodiments are shown. The embodiments of the inventive concept may, however, be embodied in many different forms and should not be construed as being limited to the embodiments set forth herein. Embodiments of the inventive concept are provided so that this disclosure will be thorough and complete, and will fully convey the concept of the inventive concept to those of ordinary skill in the art. Like reference numerals refer to like elements throughout. Furthermore, various elements and regions in the drawings are schematically drawn. Accordingly, the inventive concept is not limited by the relative size or spacing drawn in the accompanying drawings.

It will be understood that, although the terms first, second, etc. may be used herein to describe various elements, these elements should not be limited by these terms. These terms are only used to distinguish one element from another. Thus, a first element, component, region, layer or section discussed below could be termed a second element, component, region, layer or section without departing from the teachings of the disclosure.

The terminology used herein is for describing particular embodiments only and is not intended to be limiting of the inventive concept. As used herein, the singular forms “a,” “an,” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a certain embodiment may be implemented differently, a specific process order in the algorithm of the disclosure may be performed differently from the described order. For example, two consecutively described orders may be performed substantially at the same time or performed in an order opposite to the described order.

In addition, the terms “-er”, “-or”, and “module” described in the specification mean units for processing at least one function and/or operation and can be implemented by computer-based hardware components or software components running on a computer and combinations thereof.

The hardware is based on a general computer system including a main body, a keyboard, a monitor, and the like, and includes a video camera as an input device for image input.

Hereinafter, an embodiment of a method and apparatus for separating a human object from video and estimating a posture according to the disclosure will be described with reference to the accompanying drawings.

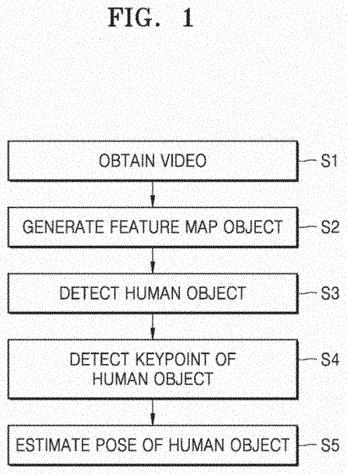

FIG. 1 shows an outline of a method of separating a human object from video and estimating a posture as a basic image processing process of the method according to the disclosure.

Step S1: A camera is used to obtain video of one or more real people.

Step S2: As a preprocessing procedure of image data, an object is formed by processing the video in units of frames. In this step, a first feature map object in the intermediate procedure having a multi-layer feature map is generated from a frame-by-frame image (hereinafter, a frame image), and a second feature map, which is a final feature map, is obtained through feature map conversion.

Step S3: Through the human object detection for the second feature map, a human object corresponding to the one or more real people existing in the frame image is detected and separated from the frame image.

Step S4: A keypoint of the human object is detected through a keypoint detection process for the human object.

Step S5: A pose or posture of the human object is estimated through the keypoint of the human object detected in the above processes.

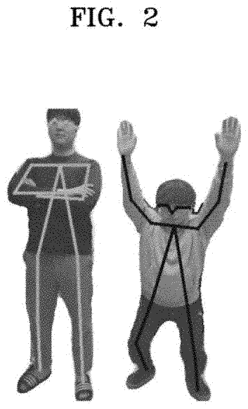

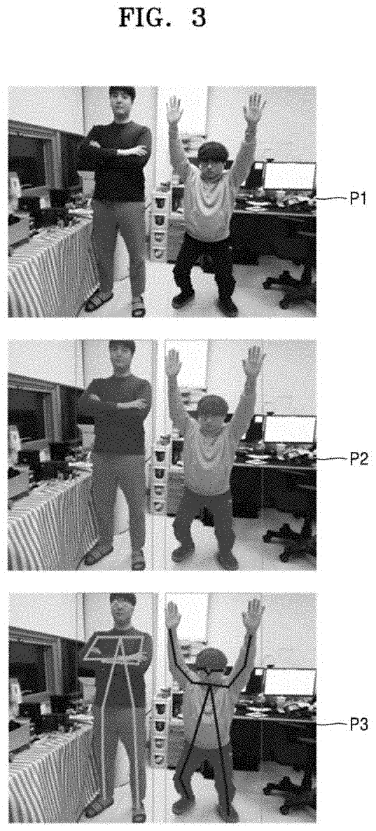

FIG. 2 is a view illustrating a result of a human object extracted and separated from a raw image through step-by-step image processing according to the above processes. FIG. 3 is a view illustrating an image processing result in a process of separating a human object.

P1 shows a raw image of a frame image separated from video. P2 shows a human object separated from the raw image using a feature map as described above. In addition, P3 shows a keypoint detection result for the human object.

In the above process, the keypoint is not detected directly from the raw image, but is detected for a human object detected and separated from the raw image.

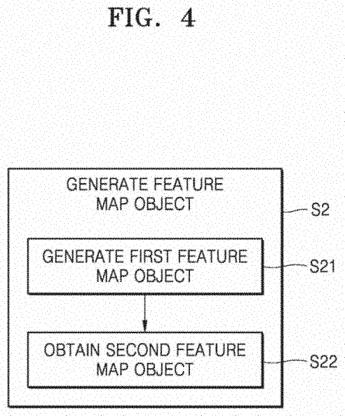

FIG. 4 shows internal processing of the feature map generation step (S2) in the above processes. According to the disclosure, generation of the feature map is performed over the second order,

wherein the first step (S21) is a step of generating a first feature map object having a multi-layer feature map, and then, a first feature map is converted to form a second feature map in the second setp (S22). This process is performed through a feature map generator, which is a software-type module for feature map generation performed on a computer.

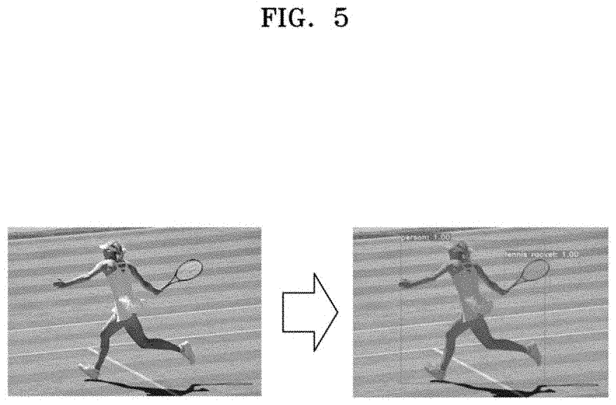

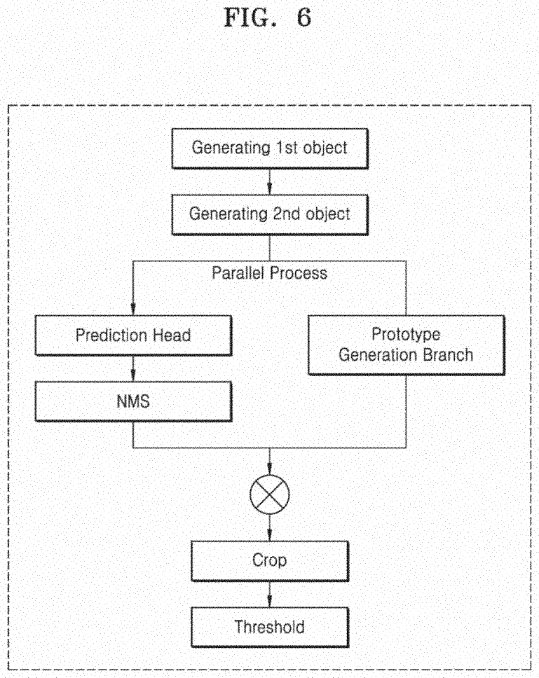

As shown in FIG. 5, the feature map generator detects a human object in a raw image (image frame) and performs instance segmentation for segmenting the human object. The feature map generator is a One-Stage Instance Segmentation module (OSIS), and it has a very fast processing speed by simultaneously performing object detection and segmentation, and has a processing procedure as shown in FIG. 6.

The first feature map object may have a size in which the multi-layer feature map is reduced in a pyramid shape, and may be generated by a convolutional neural network (CNN)-based model.

The first feature map may be implemented as a backbone network, and, for example, a Resnt50 model may be applied. The backbone network may have a number of down-sampled, for example, five feature maps of different sizes by a convolutional operation.

The second feature map may have a structure of, for example, a Feature Pyramid Network (FPN). The object converter may perform 1:1 transport convolution on the first feature map object along with upsampling. In more detail, the first feature map, for example, Backbone Networks, uses the feature map of each layer to generate a feature map with a size proportional to each layer, and has a structure in which the feature maps are combined while descending from the top layer. This second feature map may utilize both object information predicted in an upper layer and small object information in a lower layer, so is strong in scale change.

Processing on the second feature map is performed through a subsequent parallel processing procedure.

The first parallel processing procedure performs the process of Prediction Head and Non-Maximum Suppression (NMS), and the second processing procedure is a prototype generation branch process.

Prediction Head is divided into three branches: Box branch, Class branch, and Coefficient branch.

Class branch: Three anchor boxes are created for each pixel of the feature map, and the confidence of an object class is calculated for each anchor box.

Box branch: Coordinates (x, y, w, h) for the three anchor boxes are predicted.

Coefficient branch: Mask coefficients for k feature maps are predicted by adjusting each anchor box to localize only one instance.

Among predicted bounding boxes, the NMS removes the remainder except for a most accurate bounding box. The NMS determines one correct bounding box by selecting an intersection area between the bounding boxes in the total bounding box area occupied by several bounding boxes.

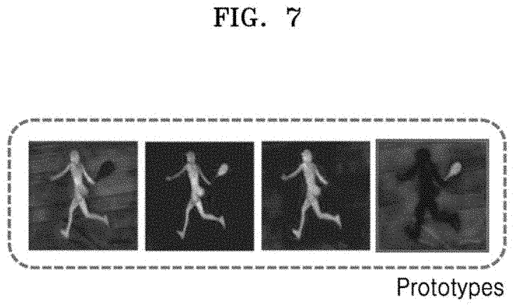

In the second parallel processing process, prototype generation, a certain number of masks, for example, k masks, are generated by extracting features from the lowest layer P3 of the FPN in several stages. FIG. 7 illustrates four types of prototype masks.

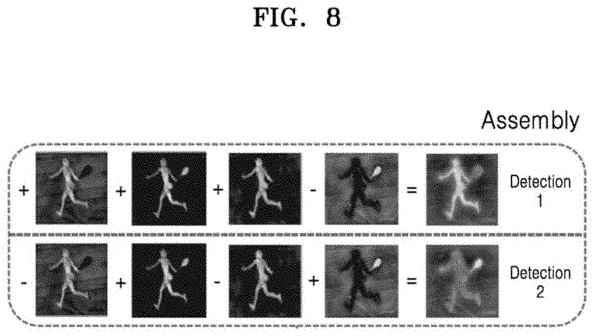

After the two parallel processing processes are performed as above, assembly ( ) linearly combines mask coefficients of a prediction head with a prototype mask to extract segments for each instance. FIG. 8 shows a detection result of a mask for each instance by combining mask coefficients with a prototype mask.

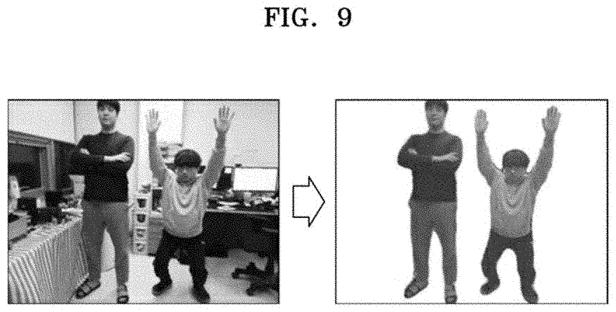

As described above, after detecting the mask for each instance, an image is cropped and a threshold is applied to determine a final mask. In applying the threshold, the final mask is determined based on a threshold value by checking a confidence value for each instance, and using this, as illustrated in FIG. 9, a human object is extracted from a video image using the final mask.

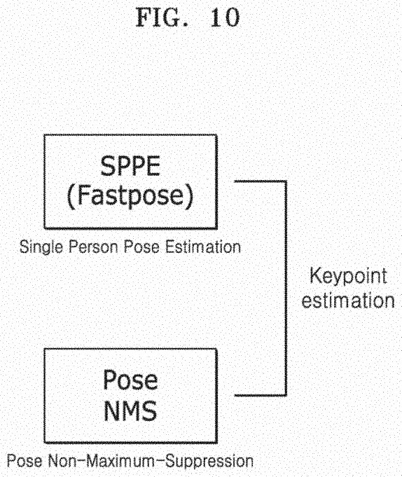

FIG. 10 shows a method of extracting a body keypoint from the human object.

The keypoint of the human object is individually extracted for every individual in the video image. Keypoints are two-dimensional coordinates in the image that can be tracked using a pre-trained deep learning model. cmu, mobilenet_thin, mobilenet_v2_large, mobilenet_v2_small, tf-pose-estimation, and openpose may be applied to the pre-trained deep learning model.

In this embodiment, Single Person Pose Estimation (SPPE) is performed on discovered human objects, and in particular, keypoint estimation or posture estimation for all human objects is performed by a top-down method, and the result is as shown in FIG. 2.

The top-down method is a two-step keypoint extraction method of estimating a pose based on bounding box coordinates of each human object. A bottom-up method is faster than the top-down method because it simultaneously estimates the position of a human object and the position of a keypoint, but it is disadvantageous in terms of accuracy, and the performance depends on the accuracy of a bounding box. Regional Multi-person Pose Estimation (RMPE) suggested by Fang et al. may be applied to this pose detection.

A conventional joint point prediction model obtains a joint point after detecting an object. However, in the method according to the disclosure, human object detection and segmentation, and finally, joint points may all be predicted by concurrently processing object segmentation in a human object detection operation.

The disclosure may be processed at a high speed by a process-based multi-threaded method, in the order of data pre-processing-object detection and segmentation-joint point prediction-image output. According to the disclosure, processes may be sequentially performed by applying apply_async, a synchronization method calling function frequently used in multiple processors, to the image output operation, or may be sequentially executed when processing the processes in parallel.

The disclosure is capable of dividing a background and an object by adding object segmentation to the existing joint point prediction model. Through this, it is possible to divide the object and the background and at the same time change the background to another image, so that a virtual background may be applied in various fields of application.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of separating a human object from video and estimating a posture, the method comprising:
obtaining video of one or more real people, using a camera;
generating a first feature map object having multi-layer feature maps down-sampled to different sizes from a frame image, by processing the video in units of frames through an object generator;
through a feature map converter, obtaining an upsampled multi-layer feature map by upsampling the multi-layer feature maps of the first feature map object, and obtaining a second feature map object, by performing convolution on the upsampled multi-layer feature map with the first feature map;
detecting and separating a human object corresponding to the one or more real people from the second feature map object through an object detector; and
detecting a keypoint of the human object through a keypoint detector.

2. The method of claim 1, wherein the first feature map object has a size in which the multi-layer feature map is reduced in a pyramid shape.

3. The method of claim 1, wherein the first feature map object is generated by a convolutional neural network (CNN)-based model.

4. The method of claim 3, wherein the object detector generates a bounding box surrounding a human object from the second feature map object and a mask coefficient, and detects a human object inside the bounding box.

5. The method of claim 1, wherein the object detector generates a bounding box surrounding a human object from the second feature map object and a mask coefficient, and detects a human object inside the bounding box.

6. The method of claim 1, wherein the object detector extracts a plurality of features from the second feature map object and generates a mask of a certain size.

7. The method of claim 3, wherein the object detector extracts a plurality of features from the second feature map object and generates a mask of a certain size.

8. The method of claim 4, wherein the object detector extracts a plurality of features from the second feature map object and generates a mask of a certain size.

9. The method of claim 1, wherein the keypoint detector performs keypoint detection using a machine learning-based model, on the human object, extracts coordinates and movement of the keypoint of the human object, and provides information thereof.

10. The method of claim 3, wherein the keypoint detector performs keypoint detection using a machine learning-based model, on the human object, extracts coordinates and movement of the keypoint of the human object, and provides information thereof.

11. An apparatus for separating a human object from video and estimating a posture, the apparatus comprising:
a camera configured to obtain video from one or more real people;
an object generator configured to process video in units of frames and generate a first feature map object having multi-layer feature maps down-sampled to different sizes from a frame image;
a feature map converter configured to obtain an upsampled multi-layer feature map by upsampling the multi-layer feature maps of the first feature map object, and generate a second feature map object, by performing convolution on the upsampled multi-layer feature map with the first feature map;
an object detector configured to detect and separate a human object corresponding to the one or more real people from the second feature map object; and
a keypoint detector configured to detect a keypoint of the human object and provide information thereof.

12. The apparatus of claim 11, wherein the object generator generates the first feature map object having a size in which the multi-layer feature map is reduced in a pyramid shape.

13. The apparatus of claim 12, wherein the object generator generates the first feature map object by a convolutional neural network (CNN)-based model.

14. The apparatus of claim 11, wherein the object generator generates the first feature map object by a convolutional neural network (CNN)-based model.

15. The apparatus of claim 11, wherein the object detector generates a bounding box surrounding a human object from the second feature map object and a mask coefficient, and detects a human object inside the bounding box.

16. The apparatus of claim 11, wherein the object detector extracts a plurality of features from the second feature map object and generates a mask of a certain size.

17. The apparatus of claim 11, wherein the keypoint detector performs keypoint detection using a machine learning-based model, on the human object, extracts coordinates and movement of the keypoint of the human object, and provides information thereof.
